(19) United States
(12) Patent Application Publication
(10) Pub. No.: US 2023/0276034 A1
(43) Pub. Date: Aug. 31, 2023

(54) Method and system for adjusting projection dithering

(71) Applicant: IVIEW DISPLAYS (SHENZHEN) COMPANY LTD., Shenzhen (CN)

(72) Inventors: Ziguang Zhou, Shenzhen (CN); Mingnei Ding, Shenzhen (CN); Tak Yeung, Hongkong (CN); Steve Yeung, Hongkong (CN); Zhiqiang Gao, Hongkong (CN)

(21) Appl. No.: 18/311,965

(22) Filed: May 4, 2023

Related U.S. Application Data
(63) Continuation of application No. PCT/CN2021/123078, filed on Oct. 11, 2021.

(30) Foreign Application Priority Data
Nov. 9, 2020 (CN) 202011242370.8

(51) Int. Cl. H04N 9/31; G06T 5/00

(52) U.S. Cl. CPC H04N 9/3179; G06T 5/002; H04N 9/3141; G06T 2207/30204

(57) ABSTRACT

The present application relates to the technical field of digital projection and discloses a method and a system for adjusting projection dithering. The method includes follow steps: respectively setting a dithering parameter to at least two values within a preset value range, respectively acquiring projection images when the dithering parameter takes different values, calculating definition values of the projection images and obtaining a target dithering value according to the definition values of the projection images; and saving the target dithering value to an optical machine. In this way, the projection dither can be automatically adjusted to the optimal position according to the target dithering value, and the projection picture is more stable and clearer.

### CROSS-REFERENCE TO RELATED APPLICATIONS

The present application claims priority to Chinese Patent Application No. 202011242370.8 filed with the Chinese Patent Office on Nov. 9, 2020, titled “METHOD AND SYSTEM FOR ADJUSTING PROJECTION DITHERING”, the entire contents of which are incorporated herein by reference.

### TECHNICAL FIELD OF THE INVENTION

The present application relates to the technical field of digital projection, and in particular, relates to a method and system for adjusting projection dithering.

### BACKGROUND OF THE INVENTION

With the increasing application of projectors in all walks of life and various scenes in recent years, customers have put forward higher requirements for the practical application of projectors.

The traditional judgment of the effect of the projection dither is based on the observation of a specific picture with human eyes, which can only judge the approximate position, and the judgment of the effect of the dither is very inaccurate, thus affecting the resolution and quality of the projection picture.

### SUMMARY OF THE INVENTION

Based on the above description, it is necessary to provide a method and system for adjusting projection dithering for the above technical problem so as to make the projection picture stable and clear.

In a first aspect, an embodiment of the present application provides a method for adjusting projection dithering, the method includes: respectively setting a dithering parameter to at least two values within a preset value range, respectively acquiring projection images when the dithering parameter takes different values, calculating definition values of the projection images and obtaining a target dithering value according to the definition values of the projection images; saving the target dithering value to an optical machine.

In some embodiments, the dithering parameter includes a first dithering parameter and a second dithering parameter, and the target dithering value includes a first target dithering value and a second target dithering value; the step of respectively setting a dithering parameter to at least two values within a preset value range, respectively acquiring projection images when the dithering parameter takes different values, calculating definition values of the projection images and obtaining a target dithering value according to the definition values of the projection images includes: setting the first dithering parameter to a first preset value, respectively setting the second dithering parameter to at least two values within a preset value range, and respectively acquiring projection images when the first dithering parameter is the first preset value and the second dithering parameter takes different values; calculating definition values of the projection images; determining the value of the second dithering parameter corresponding to the projection image with the largest definition value as the second target dithering value; setting the second dithering parameter to the second target dithering value, setting the first dithering parameter to at least two values within a preset value range, and respectively acquiring projection images when the second dithering parameter is the second target dithering value and the first dithering parameter takes different values; calculating definition values of the projection images; determining the value of the first dithering parameter corresponding to the projection image with the largest definition value as the first target dithering value.

In some embodiments, the step of calculating definition values of the projection images includes: matching the projection images according to a specific mark to obtain a specific-area projection image; processing the specific-area projection image to obtain a processed projection image; acquiring a preset value of the processed projection image, wherein the preset value is used for distinguishing high-frequency signals from low-frequency signals; acquiring a ratio of the number of high-frequency signals to the total number of signals for the processed projection image based on the preset value; performing logarithmic change on the ratio of the number of high-frequency signals to the total number of signals for the processed projection image to obtain the definition value.

In some embodiments, the logarithmic change is log 10(PR*100), wherein PR is the ratio of the number of high-frequency signals to the total number of signals for the processed projection image.

In some embodiments, the step of processing the specific-area projection image to obtain a processed projection image includes: performing Gaussian filtering on the specific-area projection image to remove noise; and processing the de-noised specific-area projection image by using a Fourier function to obtain the processed projection image.

In some embodiments, the method further includes: driving the optical machine to project according to the first target dithering value and the second target dithering value.

In some embodiments, the method further includes: presetting at least one of an exposure value, a gain value, a focal length, a frame number and distortion calibration data of a lens.

In a second aspect, an embodiment of the present application further provides a system for adjusting projection dithering, which includes: an image acquisition unit, a control unit and a projection unit, wherein the control unit is connected with the image acquisition unit and the projection unit respectively; the control unit is configured to control the image acquisition unit to acquire a projection image and control the projection unit to project; wherein the control unit includes: at least one processor; and a memory communicatively connected to the at least one processor; wherein the memory stores instructions executable by the at least one processor, and the instructions are executed by the at least one processor to enable the at least one processor to perform the method for adjusting projection dithering described above.

In some embodiments, the projection unit includes an optical machine and a driving board, and the optical machine is connected with the driving board, the driving board is configured to receive control information sent by the control unit and drive the optical machine to project according to the control information.

In a third aspect, an embodiment of the present application further provides a nonvolatile computer-readable storage medium, wherein the computer-readable storage medium stores computer-executable instructions which, when executed by a processor, enable the processor to perform the method for adjusting projection dithering described above.

In a fourth aspect, an embodiment of the present application further provides a computer program product, wherein the computer program product includes a computer program stored on a nonvolatile computer-readable storage medium, and the computer program includes program instructions which, when executed by an electronic apparatus, enable the electronic apparatus to perform the method as described above.

Beneficial effects of the present application are as follows: the method and the system for adjusting projection dithering in the embodiments of the present application respectively set a dithering parameter to at least two values within a preset value range, then respectively acquire projection images when the dithering parameter takes different values, and then calculate definition values of the projection images and obtain a target dithering value according to the definition values of the projection images, and finally save the target dithering value to an optical machine, so that the projection dither can be automatically adjusted to the optimal position according to the target dithering value, and the projection picture is more stable and clear.

### BRIEF DESCRIPTION OF DRAWINGS

One or more embodiments are illustrated by pictures in corresponding attached drawings, and this does not constitute limitation on the embodiments. Elements/modules and steps with the same reference numerals in the attached drawings are shown as similar elements/modules and steps, and the pictures in the attached drawings do not constitute scale limitation unless otherwise stated particularly.

FIG. 1 is a structural diagram of a system for adjusting projection dithering according to an embodiment of the present application.

FIG. 2 is a schematic view of the hardware structure of a control unit according to an embodiment of the present application.

FIG. 3 is a schematic flowchart diagram of a method for adjusting projection dithering according to an embodiment of the present application.

FIG. 4 is a schematic flowchart diagram of acquiring a target dithering value according to an embodiment of the present application.

FIG. 5 is a schematic flowchart diagram of determining a definition value according to an embodiment of the present application.

FIG. 6 is a schematic view of logarithmic change according to an embodiment of the present application.

FIG. 7 is a schematic view illustrating relationships between the definition value and a second dithering parameter according to an embodiment of the present application.

FIG. 8 is a schematic view illustrating relationships between the definition value and a first dithering parameter according to an embodiment of the present application.

FIG. 9 is a schematic structural diagram of a device for adjusting projection dithering according to an embodiment of the present application.

### DETAILED DESCRIPTION OF THE INVENTION

In order to make purposes, technical solutions and advantages of embodiments of the present application clearer, the technical solutions in the embodiments of the present application will be described clearly and completely with reference to the attached drawings in the embodiments of the present application; obviously, the embodiments described are only part but not all of the embodiments of the present application. Based on the embodiments in the present application, all other embodiments obtained by those of ordinary skill in the art without creative labor shall belong to the scope claimed in the present application.

It shall be noted that, features in embodiments of the present application may be combined with each other without conflict, and all the combinations are within the scope claimed in the present application. In addition, although functional module division is made in the schematic view of the device and logical sequences are shown in the flowchart diagram, in some cases, steps shown or described may be executed in a manner different from the module division in the device or in a sequence different from that in the flowchart diagram. Furthermore, words such as “first”, “second” and “third” used in the present application do not limit the data and execution order, but only distinguish the same or similar items with basically the same functions and effects.

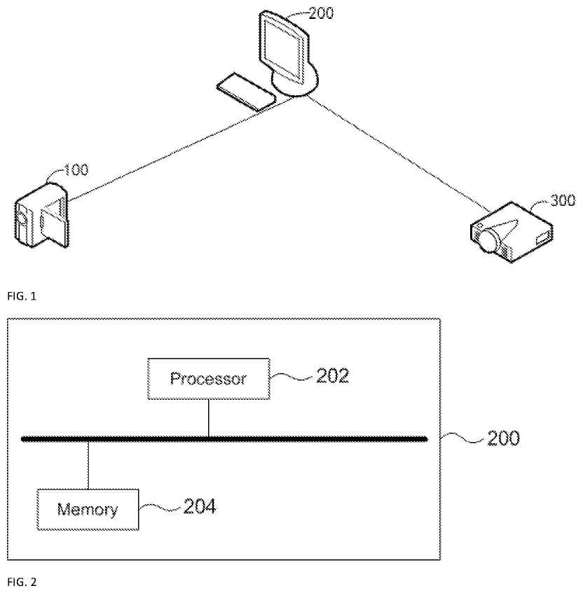

An embodiment of the present application provides a system for adjusting projection dithering, referring to FIG. 1, the system 1 includes an image acquisition unit 100, a control unit 200 and a projection unit 300, and the control unit 200 is connected with the image acquisition unit 100 and the projection unit 300 respectively.

The image acquisition unit 100 may be any type of apparatus with the image acquisition function. In the embodiment of the present application, the image acquisition unit 100 uses a combination of an industrial camera and a lens to acquire a projection image. Specifically, the industrial camera may for example adopt BFS-U3-200S6M-C series, the industrial camera is equipped with a sensor of high bandwidth and high sensitivity so as to have high resolution, and the lens may adopt MT2514C-5M series which can automatically adjust the focal length and exposure, thereby making the quality of the image acquired better.

The projection unit 300 may be any type of apparatus with the projection function. The projection unit 300 may be for example a telephoto projector, which can ensure that the projection picture is projected to a relatively long distance, and the picture size is moderate and the brightness is appropriate. The projection unit 300 includes an optical machine and a driving board, wherein the optical machine further includes an LED lamp and an industrial video camera, the optical machine is electrically connected with the driving board, and the driving board is used for receiving control information sent by the control unit 200 and driving the optical machine to project according to the control information.

The control unit 200 may be any type of apparatus with the computing function and the control capability, which may for example be a personal computer or a computer or the like. The control unit 200 is configured to control the image acquisition unit 100 to acquire a projection image, and the control unit 200 is further configured to analyze the projection image and send control information to the projection unit 300 so as to drive the projection unit 300 to project.

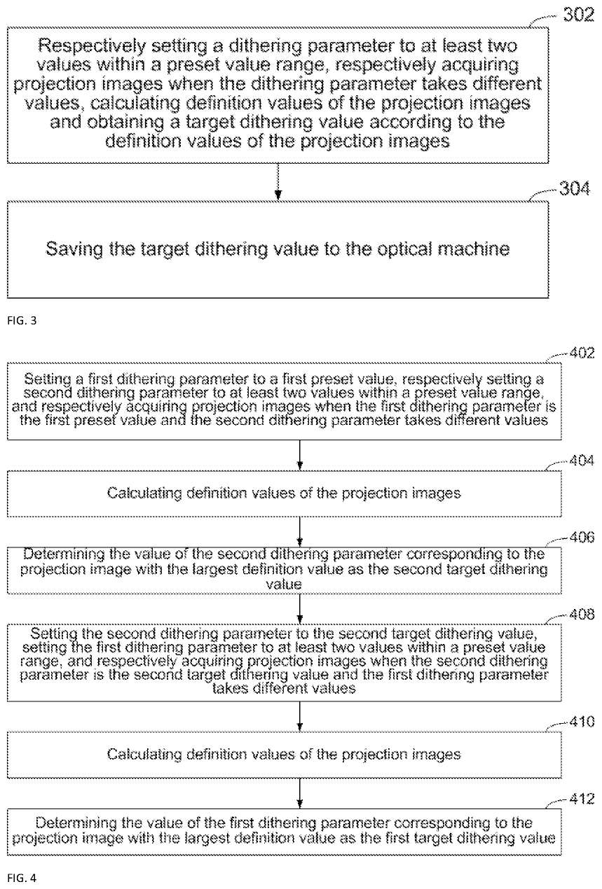

FIG. 2 is a schematic view of the hardware structure of the control unit provided by the embodiment of the present application, and as shown in FIG. 2, the control unit 200 includes one or more processors 202 and a memory 204. One processor 202 is taken as an example in FIG. 2.

As a nonvolatile computer-readable storage medium, the memory 204 may be used to store nonvolatile software programs, nonvolatile computer executable programs and modules, such as programs, instructions and modules corresponding to the method for adjusting projection dithering in the embodiment of the present application. The processor 202 executes various functional applications and data processing of the processor, i.e., implement the method for adjusting projection dithering provided by the above embodiments of the method, by running the nonvolatile software programs, instructions and modules stored in the memory 204.

The memory 204 may include a program storage area and a data storage area, wherein the program storage area may store operating systems and application programs required by at least one function; and the data storage area may store data created according to the use of the device for adjusting projection dithering or the like. In addition, the memory 204 may include a high-speed random access memory and may also include a nonvolatile memory, such as at least one magnetic disk memory device, flash memory device, or other nonvolatile solid-state memory device. In some embodiments, the memory 204 optionally includes memories remotely provided relative to the processor 202, and these remote memories may be connected to the device for adjusting projection dithering through a network. Examples of the above network include, but not limited to, the Internet, the Intranet, local area networks, mobile communication networks and combinations thereof.

As shown in FIG. 3, an embodiment of the present application provides a method for adjusting projection dithering, and the method is performed by a control unit and includes follow steps.
Step 302: respectively setting a dithering parameter to at least two values within a preset value range, respectively acquiring corresponding projection images when the dithering parameter takes different values, calculating definition values of the projection images and obtaining a target dithering value according to the definition values of the projection images.

In the embodiment of the present application, the preset value range is 40 to 60. The dithering parameter may be set to any two values within the preset value range of 40 to 60 according to requirements in advance. For example, the dithering parameters may be set in an ascending order of the value range, or the dithering parameters may be set in a descending order of the value range. Further speaking, the quality, i.e., definition and stability, of the projection image is affected by the dithering parameters, and the quality of the projection images obtained based on different dithering parameters is different. Specifically, the dithering parameter is respectively set to at least two values within a preset value range (i.e., 40 to 60) in advance, and then projection images when the dithering parameter takes different values within the value range are acquired respectively, and then definition values of the projection images are calculated and a target dithering parameter is obtained according to the definition values of the projection images.

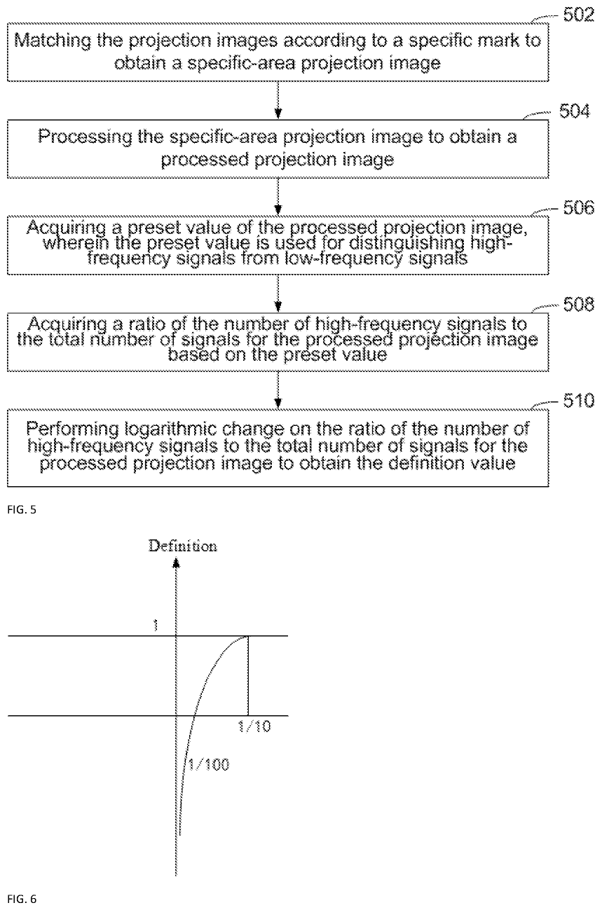

As an implementation of step 302, as shown in FIG. 4, the method further includes follow steps.
Step 402: setting a first dithering parameter to a first preset value, respectively setting a second dithering parameter to at least two values within a preset value range, and respectively acquiring projection images when the first dithering parameter is the first preset value and the second dithering parameter takes different values.

In the embodiment of the present application, the dithering parameter includes the first dithering parameter and the second dithering parameter, and the target dithering value includes a first target dithering value and a second target dithering value. For example, for ease of understanding, the first dithering parameter is denoted by B and the second dithering parameter is denoted by D. Specifically, the first dithering parameter B is set to a first preset value of 40, and then the second dithering parameter D is respectively set to at least two values within a preset value range of 40 to 60, such as 40 and 57, and then the projection image when the first dithering parameter B is the first preset value of 40 and the second dithering parameter D is 40 as well as the projection image when the first dithering parameter B is 40 and the second dithering parameter D is 57 are acquired.
Step 404: calculating definition values of the projection images.

Specifically, after acquiring the projection images when the first dithering parameter is the first preset value and the second dithering parameter takes different values, the definition values of the projection images are calculated.

As an implementation of step 404, referring to FIG. 5, the method further includes follow steps.
Step 502: matching the projection images according to a specific mark to obtain a specific-area projection image.

In the embodiment of the present application, the specific mark is a mark obtained by intercepting any area in the projection image, so that the obtained specific-area projection image is random; and when the specific mark is obtained, the specific mark is matched with the projection images; specifically, the specific mark is matched with each area of the projection image one by one so as to obtain the specific-area projection image containing the specific mark.
Step 504: processing the specific-area projection image to obtain a processed projection image.

When the specific-area projection image containing the specific mark is obtained, a series of processing is performed on the specific-area projection image, thereby obtaining the processed projection image. Further speaking, firstly, Gaussian filtering is performed on the specific-area projection image to remove noise; specifically, each pixel in the specific-area projection image is scanned by a template, i.e., convolution or a mask, and then the weighted average gray value of pixels in the neighborhood determined by the template is used to replace the value of the central pixel point of the template, thereby achieving the goal of removing noise. After the noise of the specific-area projection image is removed using Gaussian filtering, Fourier transformation is performed on the de-noised specific-area projection image using a Fourier function so as to obtain the processed projection image. Using Fourier transformation to process images belongs to the prior art and will not be further described herein.
Step 506: acquiring a preset value of the processed projection image, wherein the preset value is used for distinguishing high-frequency signals from low-frequency signals.

In the embodiment of the present application, the preset value is the average value of pixel points of the processed projection image, and through the preset value, high-frequency signals can be clearly distinguished from low-frequency signals; that is, signals lower than the preset value (i.e., the average value) are low-frequency signals, and signals higher than the preset value are high-frequency signals.
Step 508: acquiring a ratio of the number of high-frequency signals to the total number of signals for the processed projection image based on the preset value.

Specifically, firstly, the number of high-frequency signals higher than the preset value is acquired, then the total number of signals is acquired, and then the ratio of the number of high-frequency signals to the total number of signals is obtained by dividing the number of high-frequency signals by the total number of signals.
Step 510: performing logarithmic change on the ratio of the number of high-frequency signals to the total number of signals for the processed projection image to obtain the definition value.

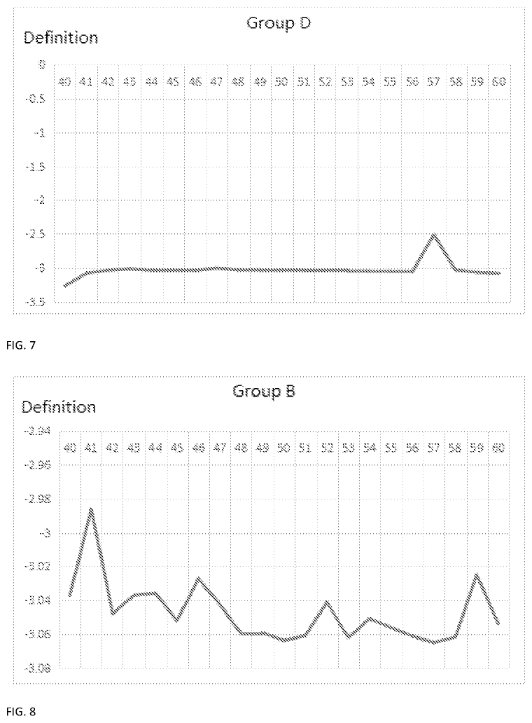

In the embodiment of the present application, the definition value of the projection image is obtained by performing logarithmic change on the ratio of the number of high-frequency signals to the total number of signals. Further speaking, as shown in FIG. 6, the logarithmic change is log 10(PR*100), wherein PR is the ratio of the number of high-frequency signals to the total number of signals for the processed projection image.
Step 406: determining the value of the second dithering parameter corresponding to the projection image with the largest definition value as the second target dithering value.

In the embodiment of the present application, the second target dithering value indicates that the definition value of the projection image is the largest, that is, the image is the clearest. When the definition value of the projection image obtained by using the second dithering parameter is the largest, the second dithering parameter is determined as the second target dithering value. Continuing with the above example, as shown in FIG. 7, when the value of the first dithering parameter B is 40 and the value of the second dithering parameter D is 57, the definition value of the image is the largest, and then the value of 57 for the second dithering parameter D is determined as the second target dithering value.
Step 408: setting the second dithering parameter to the second target dithering value, setting the first dithering parameter to at least two values within a preset value range, and respectively acquiring projection images when the second dithering parameter is the second target dithering value and the first dithering parameter takes different values.

In the embodiment of the present application, the definition of the image is influenced by the first dithering parameter and second dithering parameter, and after it is determined that the definition value of the image obtained when the second dithering parameter is 57 is the largest, the definition test is continued; for example, the second dithering parameter D is set to 57 and the first dithering parameter B is set to 40 and 41, and then the projection image when the second dithering parameter D is 57 and the first dithering parameter B is 40 as well as the projection image when the second dithering parameter D is 57 and the first dithering parameter B is 41 are acquired.
Step 410: calculating definition values of the projection images.

The definition of the projection images is calculated by steps 502 to 510.
Step 412: determining the value of the first dithering parameter corresponding to the projection image with the largest definition value as the first target dithering value.

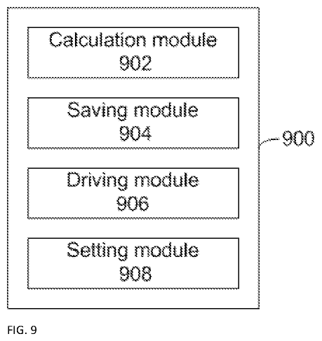

In the embodiment of the present application, the first target dithering value is also used to indicate that the definition value of the projection image is the largest. Continuing with the above example, as shown in FIG. 8, when the value of the second dithering parameter D is 57 and the value of the first dithering parameter B is 41, the definition value of the image is the largest, and then the value of 41 for the first dithering parameter B is determined as the first target dithering value.

In some embodiments, when the first dithering parameter B is 40 and the second dithering parameter D is 57, the definition value of the image is the largest, and when the second dithering parameter D is 57 and the first dithering parameter B is 41, the definition value of the image is the largest, and thus the same second dithering parameter D corresponds to different first dithering parameters B; because the definition of the image is affected by the first dithering parameter and the second dithering parameter, retesting is necessary in order to ensure that the definition value of the finally obtained projection image is the largest. Specifically, the first dithering parameter B is set to 41 to acquire the projection image when the second dithering parameter D is 57, and the second dithering parameter is set to 57 to obtain the projection image when the first dithering parameter is 40, and then the definition values are calculated by the above method; finally, it is determined that the definition value of the projection image when the first dithering parameter B is 41 and the second dithering parameter D is 57 is the largest, and then the first dithering parameter is determined as the final first target dithering value, and the second dithering parameter is determined as the final second target dithering value.
Step 304: saving the target dithering value to the optical machine.

Specifically, the target dithering value is the value that makes the quality of the projection image best, that is, the target dithering parameter is the value that makes the projection image clearest and stable. After the target dithering value is obtained, the target dithering value is stored in the optical machine, which is convenient for driving the optical machine to project subsequently based on the target dithering value.

In the embodiment of the present application, the dithering parameter is respectively set to at least two values within a preset value range, then projection images when the dithering parameter takes different values are respectively acquired, and then definition values of the projection images are calculated and a target dithering value is obtained according to the definition values of the projection images, and finally the target dithering value is saved to the optical machine, so that the projection dither can be automatically adjusted to the optimal position according to the target dithering value, and the projection picture is more stable and clear.

In some embodiments, the method further includes presetting at least one of an exposure value, a gain value, a focal length, a frame number and distortion calibration data of a lens.

Specifically, in order to ensure that the projection picture acquired has the best quality, it is necessary to initialize the lens in advance and set at least one of the exposure value, the gain value, the focal length, the frame number and the distortion calibration data of the lens in the image acquisition unit.

In some embodiments, the method further includes the step of driving the optical machine to project according to the first target dithering value and the second target dithering value.

Specifically, after the first target dithering value and the second target dithering value are saved to the optical machine, the control unit controls the driving board of the optical machine so that the driving board drives the optical machine to project according to the first target dithering value and the second target dithering value, thereby making the projection picture clearer and stable.

It shall be noted that, in the embodiments described above, there is not necessarily a certain sequence between the above-mentioned steps; as shall be appreciated by those of ordinary skill in the art according to the description of the embodiment of the present application, in different embodiments, the above-mentioned steps may be executed in a different sequence, that is, these steps may be executed in parallel, or the order in which these steps are executed may be exchanged, and so on.

Correspondingly, an embodiment of the present application further provides a device 900 for adjusting projection dithering, and as shown in FIG. 9, the device 900 includes: a calculation module 902, being configured to respectively set a dithering parameter to at least two values within a preset value range, respectively acquire projection images when the dithering parameter takes different values, calculate definition values of the projection images and obtain a target dithering value according to the definition values of the projection images, a saving module 904, being configured to save the target dithering value to an optical machine.

The device for adjusting projection dithering provided according to the embodiment of the present application respectively sets a dithering parameter to at least two values within a preset value range, then respectively acquires projection images when the dithering parameter takes different values, and then calculates definition values of the projection images by the calculation module and obtains a target dithering value according to the definition values of the projection images, and finally saves the target dithering value to an optical machine using the saving module, so that the projection dither can be automatically adjusted to the optimal position according to the target dithering value, and the projection picture is more stable and clear.

Optionally, in other embodiments of the device, as shown in FIG. 9, the device 900 further includes: a driving module 906, being configured to drive the optical machine to project according to the first target dithering value and the second target dithering value.

Optionally, in other embodiments of the device, as shown in FIG. 9, the device 900 further includes: a setting module 908, being configured to preset at least one of an exposure value, a gain value, a focal length, a frame number and distortion calibration data of a lens.

Optionally, in other embodiments of the device, the calculating module 902 is specifically configured to: set a first dithering parameter to a first preset value, respectively set a second dithering parameter to at least two values within a preset value range, and respectively acquire projection images when the first dithering parameter is the first preset value and the second dithering parameter takes different values; calculate definition values of the projection images; determine the value of the second dithering parameter corresponding to the projection image with the largest definition value as the second target dithering value; set the second dithering parameter to a second target dithering value, set the first dithering parameter to at least two values within a preset value range, and respectively acquire projection images when the second dithering parameter is the second target dithering value and the first dithering parameter takes different values; calculate definition values of the projection images; determine the value of the first dithering parameter corresponding to the projection image with the largest definition value as the first target dithering value; match the projection images according to a specific mark to obtain a specific-area projection image; process the specific-area projection image to obtain a processed projection image; acquire a preset value of the processed projection image, wherein the preset value is used for distinguishing high-frequency signals from low-frequency signals; acquire a ratio of the number of high-frequency signals to the total number of signals for the processed projection image based on the preset value; perform logarithmic change on the ratio of the number of high-frequency signals to the total number of signals for the processed projection image to obtain the definition value; perform Gaussian filtering on the specific-area projection image to remove noise; and process the de-noised specific-area projection image by using a Fourier function to obtain the processed projection image.

Optionally, in other embodiments of the device, the dithering parameter includes a first dithering parameter and a second dithering parameter, and the target dithering value includes a first target dithering value and a second target dithering value.

Optionally, in other embodiments of the device, the logarithmic change is log 10(PR*100), wherein PR is the ratio of the number of high-frequency signals to the total number of signals for the processed projection image.

It shall be noted that, the device for adjusting projection dithering described above may perform the method for adjusting projection dithering provided according to the embodiment of the present application, and have functional modules and beneficial effects for performing the method; for technical details not described in detail in the embodiment of the device for adjusting projection dithering according to the present application, reference may be made to the method for adjusting projection dithering provided according to the embodiment of the present application.

An embodiment of the present application further provides a nonvolatile computer-readable storage medium storing computer executable instructions, and the computer executable instructions, when executed by one or more processors, may enable the one or more processors described above to perform the method for adjusting projection dithering in any embodiment of the method described above.

The embodiment of the device described above is only for illustrative purpose, the units illustrated as separate components may be or may not be physically separated, and components displayed as units may be or may not be physical units; that is, these units and components may be located in one place or distributed over multiple network units. Some or all of the modules may be selected according to actual needs to achieve the purpose of the solution of this embodiment.

From the description of the above embodiments, those of ordinary skill in the art may clearly appreciate that each embodiment may be realized by means of software plus a general hardware platform, and of course, it may also be realized by hardware. As shall be appreciated by those of ordinary skill in the art, the implementation of all or part of the processes in the embodiment of the method described above may be completed by instructing related hardware through a computer program, the program may be stored in a computer-readable storage medium, and when it is executed, the program may include the processes of the embodiments of the methods described above. The storage medium may be a magnetic disk, an optical disk, a Read-Only Memory (ROM) or a Random Access Memory (RAM) or the like.

Finally, it shall be noted that, the above embodiments are only used to illustrate the technical solutions of the present application, and are not intended to limit the present application; under the idea of the present application, technical features in the above embodiments or different embodiments may also be combined, the steps may be implemented in any order, and many other variations in different aspects of the present application as described above are possible, and these variations are not provided in details for conciseness; although the present application has been described in detail with reference to the foregoing embodiments, those of ordinary skill in the art shall appreciate that, the technical solutions described in the foregoing embodiments may still be modified or some of the technical features may be equivalently replaced; and these modifications or replacements do not make the essence of the corresponding technical solutions deviate from the scope of the technical solutions of various embodiment of the present application.

1. A method for adjusting projection dithering comprising:
respectively setting a dithering parameter to at least two values within a preset value range;
respectively acquiring corresponding projection images when the dithering parameter takes different values;
calculating a definition value of the projection image and obtaining a target dithering value according to the definition values of the projection images;
saving the target dithering value to an optical machine.

2. The method according to claim 1, wherein the dithering parameter comprises a first dithering parameter and a second dithering parameter, and the target dithering value comprises a first target dithering value and a second target dithering value:
wherein the step of respectively setting a dithering parameter to at least two values within a preset value range, respectively acquiring corresponding projection images when the dithering parameter takes different values, calculating a definition value of the projection image and obtaining a target dithering value according to the definition values of the projection images comprises:
setting the first dithering parameter to a first preset value, respectively setting the second dithering parameter to at least two values within a preset value range, and respectively acquiring corresponding projection images when the first dithering parameter is the first preset value and the second dithering parameter takes different values;
calculating the definition value of the projection image;
determining the value of the second dithering parameter corresponding to the projection image with the largest definition value as the second target dithering value;
setting the second dithering parameter to the second target dithering value, setting the first dithering parameter to at least two values within a preset value range, and respectively acquiring projection images when the second dithering parameter is the second target dithering value and the first dithering parameter takes different values;
calculating the definition value of the projection image;
determining the value of the first dithering parameter corresponding to the projection image with the largest definition value as the first target dithering value.

3. The method according to claim 2, wherein the step of calculating the definition value of the projection images comprises:
matching the projection images according to a specific mark to obtain a specific-area projection image;
processing the specific-area projection image to obtain a processed projection image;
acquiring a preset value of the processed projection image, wherein the preset value is used for distinguishing high-frequency signals from low-frequency signals;
acquiring a ratio of the number of high-frequency signals to the total number of signals for the processed projection image based on the preset value;
performing logarithmic change on the ratio of the number of high-frequency signals to the total number of signals for the processed projection image to obtain the definition value.

4. The method according to claim 3, wherein the logarithmic change is log 10(PR*100), wherein PR is the ratio of the number of high-frequency signals to the total number of signals for the processed projection image.

5. The method according to claim 4, wherein the step of processing the specific-area projection image to obtain a processed projection image comprises:
performing Gaussian filtering on the specific-area projection image to remove noise; and
processing the de-noised specific-area projection image by using a Fourier function to obtain the processed projection image.

6. The method according to claim 2, wherein the method further comprises:
driving the optical machine to project according to the first target dithering value and the second target dithering value.

7. The method according to claim 1, wherein the method further comprises:
presetting at least one of an exposure value, a gain value, a focal length, a frame number and distortion calibration data of a lens.

8. A system for adjusting projection dithering, comprising: an image acquisition unit, a control unit and a projection unit;
wherein the control unit is connected with the image acquisition unit and the projection unit respectively and configured to control the image acquisition unit to acquire a projection image and control the projection unit to project;
wherein the control unit comprises;
at least one processor; and
a memory communicatively connected to the at least one processor; wherein the memory stores instructions executable by the at least one processor, and the instructions are executed by the at least one processor to enable the at least one processor to perform the method according to claim 1.

9. The system according to claim 8, wherein the projection unit comprises an optical machine and a driving board, and the optical machine is connected with the driving board, the driving board is configured to receive control information sent by the control unit and drive the optical machine to project according to the control information.

10. A computer program product, wherein the computer program product comprising a computer program stored on a nonvolatile computer-readable storage medium, the computer program comprising program instructions which, when executed by an electronic apparatus, enable the electronic apparatus to perform the method according to claim 1.
